(19) United States
(12) Patent Application Publication
(10) Pub. No.: US 2013/0335308 A1
(43) Pub. Date: Dec. 19, 2013

(54) Liquid Crystal Display Panel

(71) Applicants: Je-hao Hsu, Shenzhen (CN); Xiaohui Yao, Shenzhen (CN); Chengcai Dong, Shenzhen (CN); Shyh-Feng Chen, Shenzhen (CN)

(72) Inventors: Je-hao Hsu, Shenzhen (CN); Xiaohui Yao, Shenzhen (CN); Chengcai Dong, Shenzhen (CN); Shyh-Feng Chen, Shenzhen (CN)

(73) Assignee: SHENZHEN CHINA STAR OPTOELECTRONICS TECHNOLOGY CO. LTD., Shenzhen (CN)

(21) Appl. No.: 13/579,035

(22) PCT Filed: Jun. 18, 2012
(86) PCT No.: PCT/CN12/77061

§ 371 Date: Aug. 15, 2012

(30) Foreign Application Priority Data
Jun. 13, 2012 (CN) 201210194331.4

(51) Int. Cl. G09G 3/36

(52) U.S. Cl. 345/92; 345/87

(57) ABSTRACT

A liquid crystal display (LCD) panel is proposed. The LCD panel includes a plurality of scan lines, a plurality of data lines, and a plurality of matrix-arranged pixels. Each of the plurality of pixels includes a plurality of subpixels. Each of the plurality of subpixels is electrically connected to a corresponding scan line. The subpixels of each of the pixels are electrically connected to a data line. Each of the plurality of subpixels includes a subpixel electrode. The subpixel electrode belonging to an N+1 subpixel partially overlaps the scan line corresponding to an N subpixel for forming a storage capacitor belonging to the N+1 subpixel itself. By means of the above-mentioned method, both of the aperture ratio of the pixel and the transmittance of the LCD and are increased. Moreover, the cost of the LCD panel is reduced.

### BACKGROUND OF THE INVENTION

1. Field of the Invention

The present invention relates to the field of liquid crystal displays (LCDs), and more particularly, to an LCD panel.

2. Description of the Prior Art

Please refer to FIG. 1 illustrating a schematic diagram of a pixel on a conventional LCD panel. The conventional LCD panel comprises as plurality of pixels 10. Each of the plurality of pixels 10 comprises a first subpixel 11, a second subpixel 12, and a third subpixel 13 which are arranged vertically. Because of the arrangement of the subpixels 11, 12, and 13, the width of a scan line in each of the plurality of pixels 10 is large, resulting in a low aperture ratio of the pixel and a low transmittance of the LCD panel. Moreover, a black matrix (BM) is used in the conventional LCD panel for preventing light leaks, causing the aperture ratio of the pixel to be low as well.

Therefore, an innovatory LCD panel is needed for solving the above-mentioned problem.

### SUMMARY OF THE INVENTION

An object of the present invention is to provide an LCD panel for increasing the aperture ratio of the pixel, thereby increasing the transmittance of the LCD and itself.

According to the present invention, a liquid crystal display (LCD) panel, comprises: a plurality of scan lines disposed in parallel and at intervals; a plurality of data lines insulated with the plurality of scan lines; a plurality of matrix-arranged pixels, each of the plurality of pixels comprising a first subpixel, a second subpixel, and a third subpixel which all are disposed along the data line, the first subpixel electrically connected to a first scan line and comprising a first subpixel electrode, the second subpixel electrically connected to a second scan line and comprising a second subpixel electrode, and the third subpixel electrically connected to a third scan line and comprising a third subpixel electrode; a virtual scan line, the virtual scan line and the first scan line on the LCD panel disposed at intervals along the data line. The first subpixel electrode partially overlaps the third scan line of the former pixel which is disposed along the data line for forming a first storage capacitor belonging to the first subpixel, the second subpixel electrode partially overlaps the first scan line for forming a second storage capacitor belonging to the second subpixel, the third subpixel electrode partially overlaps the second scan line for forming a third storage capacitor belonging to the third subpixel and when the first scan line indicates a first row scan line, the first subpixel electrode partially overlaps the virtual scan line for forming the first storage capacitor belonging to the first subpixel.

According to the present invention, an LCD panel, comprises: a plurality of scan lines disposed in parallel and at intervals; a plurality of data lines insulated with the plurality of scan lines; a plurality of matrix-arranged pixels, each of the plurality of pixels comprising a plurality of subpixels, each of the plurality of subpixels electrically connected to one of the scan lines, and the plurality of subpixels of each of the plurality of pixels electrically connected to one of the data lines. Each of the plurality of subpixels comprises a subpixel electrode, and the subpixel electrode belonging to an N+1 subpixel partially overlaps the scan line corresponding to an N subpixel for forming a storage capacitor belonging to the N+1 subpixel where N is an integer that is greater than or equal to one.

In one aspect of the present invention, each of the plurality of pixels comprises a first subpixel, a second subpixel, and a third subpixel which all are disposed along the data line, and wherein the first subpixel is electrically connected to a first scan line and comprises a first subpixel electrode; the second subpixel is electrically connected to a second scan line and comprises a second subpixel electrode; the third subpixel is electrically connected to a third scan line and comprises a third subpixel electrode.

In another aspect of the present invention, the first subpixel electrode partially overlaps the third scan line of the former pixel which is disposed along the data line for forming a first storage capacitor belonging to the first subpixel; the second subpixel electrode partially overlaps the first scan line for forming a second storage capacitor belonging to the second subpixel; the third subpixel electrode partially overlaps the second scan line for forming a third storage capacitor belonging to the third subpixel.

In another aspect of the present invention, the LCD panel comprises a virtual scan line, the virtual scan line and the first scan line on the LCD panel are disposed at intervals along the data line, and when the first scan line serves as the first scan line, the first subpixel electrode partially overlaps the virtual scan line for forming the first storage capacitor belonging to the first subpixel.

In another aspect of the present invention, the virtual scan line and the first scan line are disposed at both sides of the first subpixel, respectively, and the virtual scan line is disposed dose to an upper edge of the first subpixel.

In another aspect of the present invention, the LCD panel further comprises: a gate driver for supplying scan voltage to the plurality of subpixels through the plurality of scan lines; a source driver for supplying drive voltage to the plurality of subpixels through the plurality of data lines.

In another aspect of the present invention, each of the plurality of subpixels further comprises a thin-film transistor (TFT) switch, and the TFT switch comprises a gate connected to the gate driver through the scan line, a drain connected to the subpixel electrode belonging to the subpixel, and a source connected to the source driver through the data line.

In another aspect of the present invention, a width of the overlapping domain is between 2 um and 6 um.

In another aspect of the present invention, the LCD and is a PSVA mode LCD panel.

In yet another aspect of the present invention, the LCD panel is an IPS mode LCD panel.

Compared with the conventional technology, the benefits of the present invention are a higher aperture ratio of the pixel, a higher transmittance of the LCD panel, and low cost of the LCD panel. For the LCD panel of the present invention, each of a plurality of subpixels is electrically connected to a scan line, the plurality of subpixels are electrically connected to a data line, and a subpixel electrode belonging to the N+1 subpixel partially overlaps the scan line corresponding to the N subpixel for forming a storage capacitor belonging to the N+1 subpixel itself. Therefore, both of the aperture ratio of the pixel and the transmittance of the LCD panel are increased. Also, the cost of the LCD panel is reduced.

### BRIEF DESCRIPTION OF THE DRAWINGS

These and other features, aspects and advantages of the present disclosure will become understood with reference to the following description, appended claims and accompanying figures.

FIG. 1 illustrates a schematic diagram of a pixel on a conventional LCD panel.

FIG. 2 is a schematic diagram of an LCD panel 20 according to a first embodiment of the present invention.

FIG. 3 is a schematic diagram of a pixel 21 shown in FIG. 2.

FIG. 4 shows a schematic diagram of a pixel of FIG. 2 associated with the first scan line indicating a first row scan line.

FIG. 5 illustrates a subpixel in FIG. 3.

FIG. 6 shows a schematic diagram of the LCD device according to a preferred embodiment of the present invention.

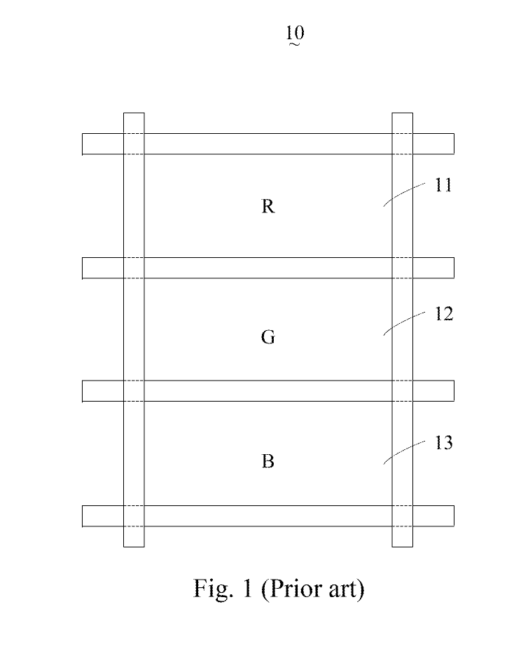

### DETAILED DESCRIPTION OF THE PREFERRED EMBODIMENTS

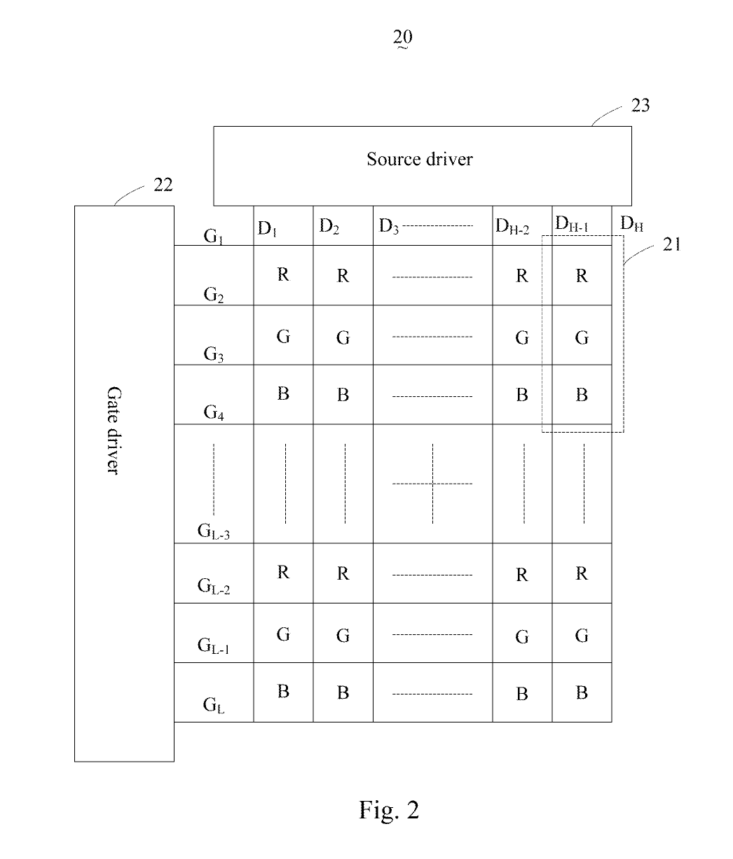

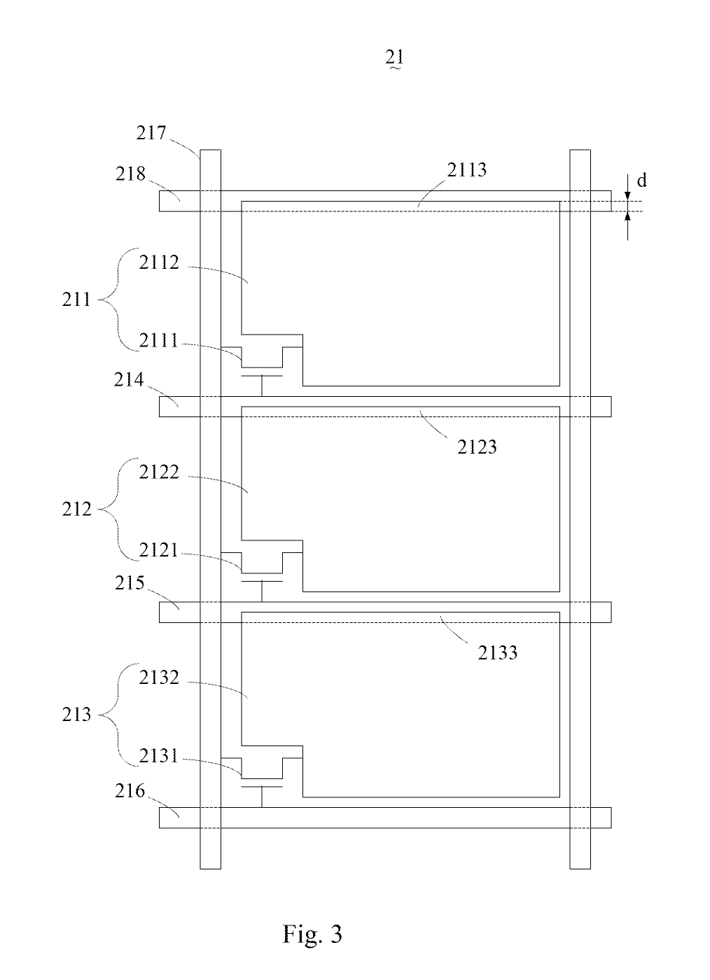

Referring to FIGS. 2 to 3, FIG. 2 is a schematic diagram of an LCD panel 20 according to a first embodiment of the present invention; FIG. 3 is a schematic diagram of a pixel 21 shown in FIG. 2. The LCD panel 20 comprises a plurality of scan lines G₁, G₂, . . . , G_{L} , a plurality of data lines D₁, D₂, . . . , D_{H}, a plurality Of pixels 21, a gate driver 22, and a source driver 23.

The plurality of scan lines G₁, G₂, . . . , G_{L} disposed in parallel. The plurality of data lines D₁, D₂, . . . , D_{H} and the plurality of scan lines G₁, G₂, . . . , G_{L} are insulated. The plurality of pixels 21 are connected to the gate driver 22 through the plurality of scan lines G₁, G₂, . . . , G_{L}, and are connected to the source driver 23 through the plurality of data lines D₁, D₂, . . . , D_{H}. The gate driver 22 supplies scan voltage to the plurality of pixels 21 through the plurality of scan lines G₁, G₂, . . . , G_{L}. The source driver 23 supplies drive voltage to the plurality of pixels 21 through the plurality of data lines D₁, D₂, . . . , D_{H}.

As shown in FIG. 3, each of the plurality of pixels 21 comprises a first subpixel 211, a second subpixel 212, and a third subpixel 213. The first subpixel 211, the second subpixel 212, and the third subpixel 213 are disposed along a data line 217. The first subpixel 211 comprises a first TFT (thin-film transistor) switch 2111 and a first subpixel electrode 2112. The second subpixel 212 comprises a second TFT switch 2121 and a second subpixel electrode 2122. The third subpixel 213 comprises a third TFT switch 2131 and a third subpixel electrode 2132.

The first TFT switch 2111 comprises a gate connected to a first scan line 214 and a drain connected to the first subpixel electrode 2112. The second IFT switch 2121 comprises a gate connected to a second scan line 215 and a drain connected to the second subpixel electrode 2122. The third TFT switch 2131 comprises a gate connected to a third scan line 216 and a drain connected to the third subpixel electrode 2132. The first TFT switch 2111, the second TFT switch 2121, and the third TFT switch 2131 all comprise a source connected to the data line 217. So the first subpixel 211 is electrically connected to the first scan line 214; the second subpixel 212 is electrically connected to the second scan line 215; the third subpixel 213 is electrically connected to the third scan line 216. In other words, the first subpixel 211, the second subpixel 212, and the third subpixel 213 all are electrically connected to the data line 217.

A scan line 218 serves as a third scan line of a former pixel disposed along the data line 217. The first subpixel electrode 2112 overlaps the scan line 218 partially for forming a storage capacitor 2113 belonging to the first subpixel 211. The second subpixel electrode 2122 overlaps the first scan line 214 partial iv for forming a storage capacitor 2123 belonging to the second subpixel 212. The third subpixel electrode 2132 overlaps the second scan line 215 partially for forming a storage capacitor 2133 belonging to the third subpixel 213. A width d of the overlapping is between 2 um and 6 um.

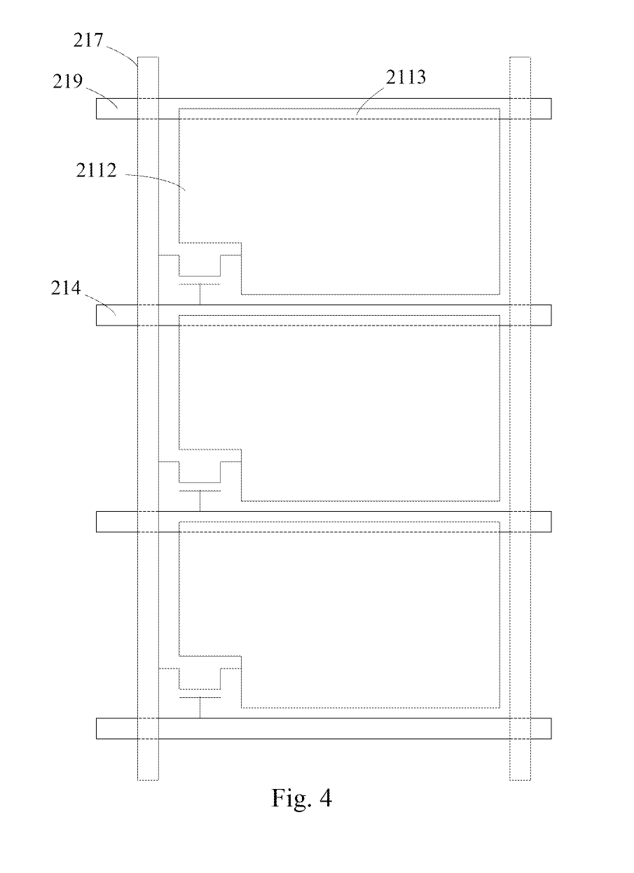

When the first scan line 214 indicates a first row scan line of the LCD panel 20, the LCD panel 20 also comprises a virtual scan line 219, as shown in FIG. 4. The virtual scan line 219 and the first scan line 214 are disposed at intervals along the data line 217. The virtual scan line 219 and the first scan line 214 are disposed at both sides of the first subpixel 211, respectively. Meanwhile, the virtual scan line 219 is disposed close to the upper edge of the first subpixel 211. The first subpixel electrode 2112 overlaps the virtual scan line 219 partially for forming a storage capacitor 2113 belonging to the first subpixel 211.

It is noted that the structure of the subpixel of the pixel 21 is the same as that of the first subpixel 211. So the detailed description of the structure of the subpixel of the pixel 21 will not herein be repeated.

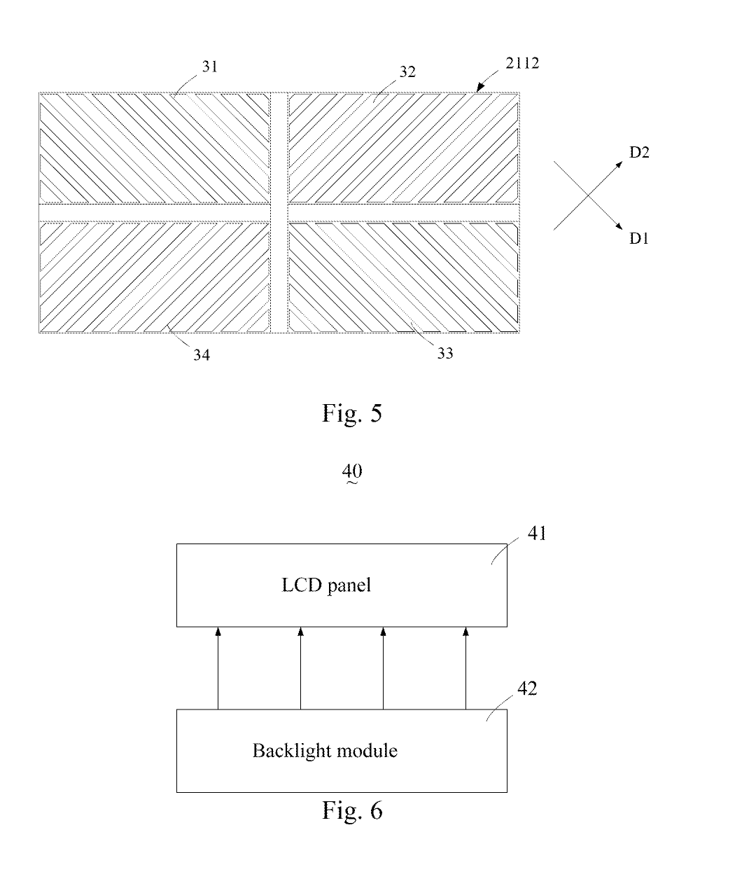

In this embodiment, the LCD panel 20 is a PSVA (short for Polymer-stabilized Vertical Alignment) mode LCD panel. As shown in FIG. 5, the first subpixel 211 comprises a first domain 31, a second domain 32. a third domain 33, and a fourth domain 34. The first domain 31 is disposed in parallel with the second domain 32. The first domain 31 and the third domain 33 are disposed in a diagonal arrangement. The second domain 32 and the fourth domain 34 are disposed in a diagonal arrangement. The electrodes of the first domain 31 and the third domain 33 are arranged along a first direction D1; the electrodes of the second domain 32 and the fourth domain 34 are arranged along, a second direction D2. In a preferred embodiment, the first direction D1 is perpendicular to the second direction D2. In another embodiment, a person with ordinary skill in the art could choose an LCD panel in a different mode, such as an IPS (short for In-Plane Switching) mode LCD panel, to serve as the LCD panel 20.

The difference between the conventional LCD panel and the LCD panel 20 of the present invention is that the subpixel electrode of the subpixel overlaps the corresponding scan line partially for forming the storage capacitor belonging to the subpixel itself in the present invention. Such a design helps increase the aperture ratio of the pixel, thereby increasing the transmittance of the LCD panel 20. In addition, the LCD panel 20 is the PSVA mode LCD panel, which could reduce the cost of the LCD panel 20.

It is noted that the pixel 21 on the LCD panel 20 comprises three subpixels in the above-mentioned embodiment. It is simply an example. Actually, the LCD panel 20 comprises M subpixels in another embodiment of the present invention. Each of the M subpixels is electrically connected to its corresponding scan line. The plurality of M subpixels are electrically connected to a data line.

Each of the plurality of subpixels comprises a subpixel electrode. The subpixel electrode belonging to an N+1 subpixel partially overlaps a scan line corresponding to an N subpixel for forming a storage capacitor belonging to the N+1 subpixel where N is an integer that is less than M and greater than or equal to one (1≦N<M).

An LCD device 40 is also provided in the present invention. The LCD device 40 comprises an LCD panel 41 and a backlight module 42. The backlight module 42 supplies the LCD panel 41 with light source. The LCD panel 41 is the same as the one used in the previous embodiment, so the detailed description of the LCD panel 41 will not herein be repeated.

To sum up, for the LCD panel 20 of the present invention, each of the plurality of subpixels is electrically connected to its corresponding scan line, the plurality of subpixels are electrically connected to a data line, and the subpixel electrode belonging to the N+1 subpixel overlaps the scan line corresponding to the N subpixel partially for forming the storage capacitor belonging to the N+1 subpixel itself. Therefore, both of the aperture ratio of the pixel and the transmittance of the LCD panel 20 are increased. Besides, the LCD panel 20 is the PSVA mode LCD panel, which reduces the cost of the LCD panel 20.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A liquid crystal display (LCD) panel, comprising:
a plurality of scan lines disposed in parallel and at intervals;
a plurality of data lines insulated with the plurality of scan lines;
a plurality of matrix-arranged pixels, each of the plurality of pixels comprising a first subpixel, a second subpixel, and a third subpixel which all are disposed along the data line, the first subpixel electrically connected to a first scan line and comprising a first subpixel electrode, the second subpixel electrically connected to a second scan line and comprising a second subpixel electrode, and the third subpixel electrically connected to a third scan line and comprising a third subpixel electrode;
a virtual scan line, the virtual scan line and the first scan line on the LCD panel disposed at intervals along the data line;
wherein the first subpixel electrode partially overlaps the third scan line of the former pixel which is disposed along the data line for forming a first storage capacitor belonging to the first subpixel, the second subpixel electrode partially overlaps the first scan line for forming a second storage capacitor belonging to the second subpixel, the third subpixel electrode partially overlaps the second scan line for forming a third storage capacitor belonging to the third subpixel, and when the first scan line indicates a first row scan line, the first subpixel electrode partially overlaps the virtual scan line for forming the first storage capacitor belonging to the first subpixel.

2. An LCD panel, comprising:
a plurality of scan lines disposed in parallel and at intervals;
a plurality of data lines insulated with the plurality of scan lines;
a plurality of matrix-arranged pixels, each of the plurality of pixels comprising a plurality of subpixels, each of the plurality of subpixels electrically connected to one of the scan lines, and the plurality of subpixels of each of the plurality of pixels electrically connected to one of the data lines;
wherein each of the plurality of subpixels comprises a subpixel electrode, and the subpixel electrode belonging to an N+1 subpixel partially overlaps the scan line corresponding to an N subpixel for forming a storage capacitor belonging to the N+1 subpixel where N is an integer that is greater than or equal to one.

3. The LCD panel as claimed in claim 2, wherein each of the plurality of pixels comprises a first subpixel, a second subpixel, and a third subpixel which all are disposed along the data line, and wherein the first subpixel is electrically connected to a first scan line and comprises a first subpixel electrode; the second subpixel is electrically connected to a second scan line and comprises a second subpixel electrode; the third subpixel is electrically connected to a third scan line and comprises a third subpixel electrode.

4. The LCD panel as claimed in claim 3, wherein the first subpixel electrode partially overlaps the third scan line of the former pixel which is disposed along the data line for forming. a first storage capacitor belonging to the first subpixel; the second subpixel electrode partially overlaps the first scan line for forming a second storage capacitor belonging to the second subpixel; the third subpixel electrode partially overlaps the second scan line for forming a third storage capacitor belonging to the third subpixel.

5. The LCD panel as claimed in claim 3, wherein the LCD panel comprises a virtual scan line, the virtual scan line and the first scan line on the LCD panel are disposed at intervals along the data line, and when the first scan line serves as the first scan line, the first subpixel electrode partially overlaps the virtual scan line for forming the first storage capacitor belonging to the first subpixel.

6. The LCD panel as claimed in claim 5, wherein the virtual scan line and the first scan line are disposed at both sides of the first subpixel, respectively, and the virtual scan line is disposed close to art upper edge of the first subpixel.

7. The LCD panel as claimed in claim 2, further comprising:
a gate driver for supplying scan voltage to the plurality of subpixels through the plurality of scan lines;
a source driver for supplying drive voltage to the plurality of subpixels through the plurality of data lines.

8. The LCD panel as claimed in claim 7, wherein each of the plurality of subpixels further comprises a thin-film transistor (TFT) switch, and the TFT switch comprises a gate connected to the gate driver through the scan line, a drain connected to the subpixel electrode belonging to the subpixel, and a source connected to the source driver through the data line.

9. The LCD panel as claimed in claim 2, wherein a width of the overlapping domain is between 2 um and 6 um.

10. The LCD panel as claimed in claim 2, wherein the LCD panel is a PSVA mode LCD panel.

11. The LCD panel as claimed in claim 2, wherein the LCD panel is an IPS mode LCD panel.
